(19) United States
(12) Patent Application Publication
(10) Pub. No.: US 2013/0173138 A1
(43) Pub. Date: Jul. 4, 2013

(54) DUAL THROTTLE ENGINE SPEED CONTROL

(71) Applicant: Clark Equipment Company, West Fargo, ND (US)

(72) Inventor: Shawn R. Vasichek, Fargo, ND (US)

(73) Assignee: Clark Equipment Company, West Fargo, ND (US)

(21) Appl. No.: 13/730,167

(22) Filed: Dec. 28, 2012

Related U.S. Application Data
(60) Provisional application No. 61/581,422, filed on Dec. 29, 2011.

(51) Int. Cl. F02D 41/00

(52) U.S. Cl. CPC F02D 41/0002
USPC 701/102

(57) ABSTRACT

Disclosed embodiments include throttle engine speed control systems, methods and power machines incorporating the same. In one embodiment, a power machine has a controllable power source that receives a command signal to control the power source. First and second throttle input devices provide first and second throttle input signals, respectively, that are indicative of actuation thereof. A controller receives and combines the first and second throttle input signals to generate the command signal.

### CROSS-REFERENCE TO RELATED APPLICATIONS

This application claims the benefit of U.S. Provisional Patent Application 61/581,422 filed on Dec. 29, 2011, the contents of which are incorporated by reference into this application in their entirety.

### FIELD

Disclosed embodiments relate to power machines with engines that are equipped with an electronic control unit (ECU) to control engine speed. More particularly, disclosed embodiments relate to throttle input control of engine speed for such power machines.

### BACKGROUND

Many power machines such as skid steer loaders, wheel loaders, track loaders, excavators, telehandlers, utility vehicles and other types of power machines utilize engines that are equipped with an electronic control unit (ECU) to control engine speed. The ECU typically receives a command signal from a throttle input that an operator can manipulate and controls the engine speed based in part on that command signal. One way of supplying a command signal to an engine ECU is via a communication network such as a controller area network (CAN) serial communication message. CAN is a standardized protocol used to send messages between one device and another on a variety of power machines and vehicles. The CAN protocol provides standardized messages to deliver certain types of information and includes a message definition for sending a command signal from a throttle input device to an ECU. The standardized CAN message for throttle control provides for two parameters, ostensibly for first and second throttle input devices. However, there is a need for improved throttle control of engine speed in power machines.

The discussion above is merely provided for general background information and is not intended to be used as an aid in determining the scope of the claimed subject matter.

### SUMMARY

Disclosed embodiments include dual or multiple throttle engine speed control systems, methods and power machines incorporating the same. In one embodiment, a power machine having a controllable power source that is configured to receive a command signal for controlling the power source is disclosed. A first throttle input device is configured to provide a first throttle input signal indicative of actuation thereof and a second throttle input device is configured to provide a second throttle input signal indicative of actuation thereof. A controller is capable of receiving the first and second input signals and combine the first and second throttle input signals to generate the command signal.

In another embodiment, a throttle input control system for generating a command signal for controlling engine speed of a power machine is disclosed. A first throttle input device provides a first throttle signal in response to actuation by an operator. A second throttle input device provides a second throttle signal in response to actuation by the operator. A controller is operably coupled to the first and second throttle input devices to receive the first and second throttle signals. The controller is coupled to the electronic control unit to provide the command signal to the electronic control unit, wherein the controller is configured to combine the first and second throttle input signals to generate the command signal.

In yet another embodiment, a method of providing a command signal to control an engine speed on a power machine is disclosed. The method includes providing a first input signal indicative of actuation of a first throttle input device and a second input signal indicative of actuation of a second throttle input device. A baseline command signal is established between a minimum engine speed signal and a maximum engine speed signal based on the first input signal. A secondary command signal is established based on the second input signal. The baseline command signal and the secondary command signal are combined to form the command signal.

This Summary and the Abstract are provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a side view of a skid steer loader embodiment of a power machine having controllers configured to implement dual throttle engine speed control methods in accordance with exemplary embodiments.

FIG. 2 is a block diagram illustrating throttle, controller and electronic control unit (ECU) components which are configured to provide improved dual throttle control of engine speed.

FIGS. 3-1 through 3-3 are graphs illustrating operational modes of a controller that provides a command signal to an ECU to control engine speed in response to outputs from dual throttle input devices.

FIG. 4 is a block diagram illustrating a method of providing a command signal for control engine speed according to one illustrative embodiment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

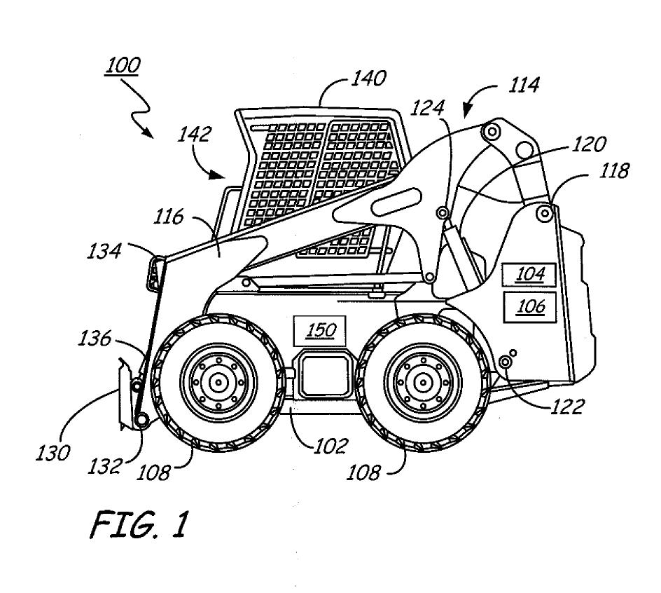

FIG. 1 is a side view of a representative power machine 100 upon which the disclosed embodiments can be employed. The power machine 100 illustrated in FIG. 1 is a skid loader, but other types of power machines such as tracked loaders, steerable wheeled loaders, including all-wheel steer loaders, excavators, and utility vehicles, to name but a few examples, may employ the disclosed embodiments. The power machine 100 includes a supporting frame or main frame 102, which supports a power source 104, which in some embodiments is an internal combustion engine. A control system 106 is operably coupled to the power source 104. Control system 106 illustratively receives power from the power source 104 and operator inputs to convert the received power to signals that operate functional components of the power machine. In some embodiments, such as with the power machine 100 in FIG. 1, the control system 106 includes hydraulic components such as one or more hydraulic pumps that are configured to provide pressurized hydraulic fluid to various actuators and valve components that are illustratively employed to control the flow of hydraulic fluid to some or all of the actuators used to control functional components of the power machine 100. Other types of control systems are contemplated. For example, the control system 106 can include electric generators or the like to generate electrical control signals to power electric actuators. For the sake of simplicity, the actuators disclosed herein are referred to as hydraulic or electrohydraulic actuators, but other types of actuators can be employed in some embodiments. Tractive elements 108 are operably coupled to the frame and are controllable by the control system 106 to selectively propel the power machine 100 over a support surface. A pair of tractive elements 108 in the form of wheels are shown in FIG. 1. The power machine 100 has a similar pair of wheels disposed on an opposite side of the frame 102. Other embodiments can have other tractive elements such endless tracks or a different number of wheels. For example, some embodiments include three or more wheels on each side of a given power machine.

The power machine 100 also includes a lift arm assembly 114 that is capable of being raised and lowered with respect to the frame 102. The lift arm assembly 114 illustratively includes a lift arm 116 that is pivotally attached to the frame 102 at attachment point 118. An actuator 120, which in some embodiments is a hydraulic cylinder configured to receive pressurized fluid from control system 106, is pivotally attached to both the frame 102 and the lift arm 116 at attachment points 122 and 124, respectively. The lift arm 116 is representative of the type of lift arm that may be attached to the power machine 100. It should be appreciated that the lift arm assembly 114 shown in FIG. 1 includes a second lift arm and actuator disposed on an opposite side of the of the power machine 100, although neither is shown in FIG. 1. It should be appreciated further that other lift arm assemblies, with different geometries and structures can be attached to the power machine 100 without departing from the scope of the present discussion.

An implement carrier 130 is pivotally attached to the lift arm 116 at attachment point 132. One or more actuators such as hydraulic tilt actuator 136 shown in FIG. 1 are pivotally attached to the implement carrier 130 and the lift arm assembly 114 to cause the implement carrier to rotate under power about an axis that extends through the attachment point 132 in response to operator input. In some embodiments, the one or more actuators pivotally attached to the implement carrier and the lift arm assembly are hydraulic cylinders capable of receiving pressurized hydraulic fluid from the control system 106. The implement carrier 130 is configured to accept and secure any one of a number of different implements to the power machine as may be desired to accomplish a particular work task. The power machine 100 provides a source 134 of power and control signals that can be coupled to an implement to control various functions on the implement, in response to operator inputs.

Power machine 100 also illustratively includes a cab 140, which is supported by the frame 102. Cab 140 defines, at least in part, an operator compartment 142. Operator compartment 142 typically includes an operator seat (not shown) and operator input devices (not shown in FIG. 1) accessible from a sitting position in the seat. When an operator is seated properly within the operator compartment, the operator can manipulate operator input devices to control such functions as driving the power machine 100, raising and lowering the lift arm assembly 114, rotating the implement carrier 130 about the lift arm assembly 114 and make power and control signals available to an implement at source 134. The signals provided at source 134 illustratively include electrical and hydraulic signals, which can be provided to electrical, electronic, and hydraulic devices on a particular implement. Operator compartment 142 can also include instrument clusters, instrument displays, and other components for providing information and receiving input from an operator.

In exemplary embodiments, the power machine 100 includes two throttle input devices that are capable of being manipulated by an operator to provide throttle input signals for controlling the power source 104. As discussed above, a power source 104 in some embodiments, is an internal combustion engine. In embodiments where the power source 104 includes an internal combustion engine, two throttle input signals are provided by the throttle input devices to control the speed of the engine. As is discussed below in more detail, input signals from the two throttle input devices can be combined in various ways to provide a signal for controlling the speed of an internal combustion engine or similar power source.

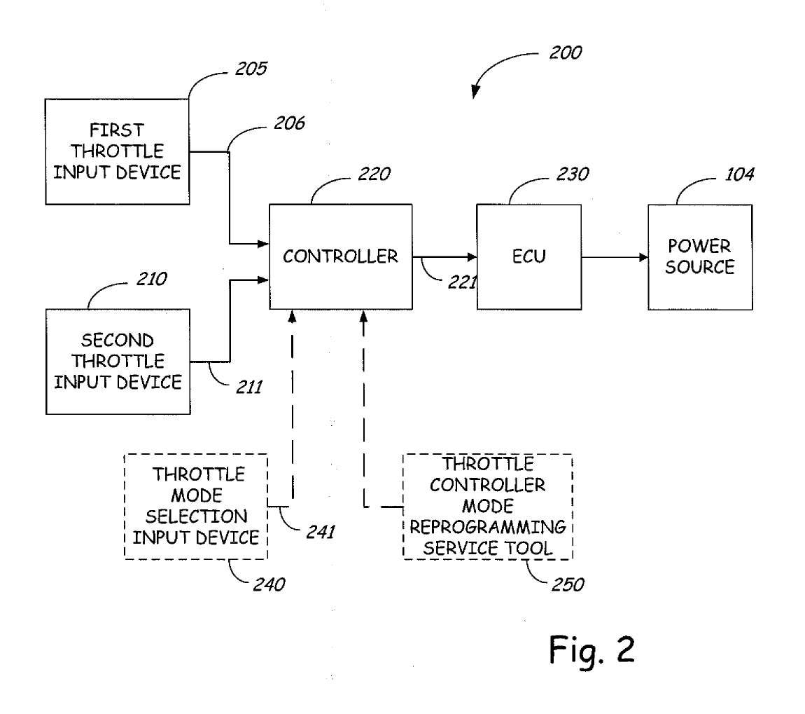

Referring now to FIG. 2, an engine speed control system 200 including a first throttle input device 205 and a second throttle input device 210 is shown. In some embodiments, each of the first and second throttle input devices 205 and 210 is a hand or foot operated control device capable of being actuated over a rotational or linear range of motion. In other embodiments, one or both of the throttle input devices 205 and 210 are implemented as finger or thumb manipulable switches, levers, paddles and the like. In still other embodiments, one or both of the first and second throttle input devices 205 and 210 are integrated into an interactive display panel, allowing the operator to select a throttle position by setting a throttle level in response to a prompt from a display. Each of the throttle input devices provides first and second throttle input signals 206 and 211, respectively, to a controller 220 on board the power machine 100. The first and second throttle input signals 206 and 211 are indicative of the position of the input device to which it is associated. For example, in instances where one of the throttle input devices is capable of being actuated over a radial path, the signal provided indicates where along that radial path the input device is positioned. The signal provided can be shaped in any way. It may be advantageous to provide more resolution in certain portions of the radial path, and thus shaping the signal in such a manner to provide such resolution can be accomplished.

Controller 220 can be implemented in any of a number of ways in various embodiments. For example, in one embodiment, controller 220 and ECU 230 are integrated into an electronic controller 150 (shown in block form in FIG. 1) on power machine 100. In other embodiments, one of the controller 220 and ECU 230 is integrated into electronic controller 150. In yet another embodiment, controller 220 is integrated into one of throttle input devices 205 and 210. It should be understood that controller 220 can thus be implemented in any electronic control device on the power machine, or be a stand-alone device. In exemplary embodiments, controller 220 provides an output command signal 221 over a network or bus, such as a CAN bus, to ECU 230. The first and second throttle input signals 206 and 211 provided by the first and second throttle input devices 205 and 210 are indicative of the desired actuation positions of the respective throttle input devices. Each of the first and second throttle input devices 205 and 210 can be configured to remember the position it is placed in by an operator. (i.e. it has a mechanism that holds the throttle input device in a given position), or can have a biasing mechanism such that it returns to an un-actuated position as soon as the operator stops actively operating or actuating it. In some embodiments, either or both of the first and second throttle input devices 205 and 210 employ a biasing mechanism that can be overridden by a selectively engagable mechanism to hold the throttle input device in a given position, despite the biasing mechanism.

Controller 220, in some embodiments, is configured to recognize first throttle input device 205 as a primary or master input and to use the first throttle input signal 206 from first throttle input device 205 to set a baseline throttle signal. The baseline throttle signal indicated by the first throttle input functions as a minimum throttle input. That is, the baseline throttle signal indicates a baseline level at which the power source 104 is to operate. Typically, the baseline level is a minimum value at which the power source 104 is to operate, but in some conditions, described below the power source 104 can be commanded to operate at a level below the baseline throttle signal. In embodiments where the controller 220 is configured to establish a baseline throttle signal from the first throttle input signal 206, controller 220 is configured to recognize and treat second throttle input device 210 as a secondary or incremental input device. The second throttle input signal 211 from the secondary throttle input device can be added to, or otherwise combined with, the baseline throttle signal by controller 220. One example of a combination of the second throttle input signal 211 with the baseline throttle input is to apply the second throttle input signal to a conditioning function. The conditioning function can be a linear function, an exponential function, or any other suitable function to condition the second throttle input signal 211 before it is combined with the baseline throttle signal to form an output command signal 221. The output command signal 221 provided by controller 220 is provided to ECU 230 as a single parameter, and ECU 230 generates engine control outputs 231 as a function of the output command signal 221. In some instances, such as when the second throttle input device 210 has a biased center position and can be actuated in two directions from the biased center position, the second throttle input signal 211, once it is applied to the conditioning function, can be subtracted from the baseline throttle signal. For example, if the second throttle input device 210 is actuated in a first direction, the conditioned second throttle input signal 211 is added to the baseline throttle input. However, if the throttle input device 210 is actuated in a second direction, the conditioned second throttle input signal 211 is subtracted from the baseline throttle input.

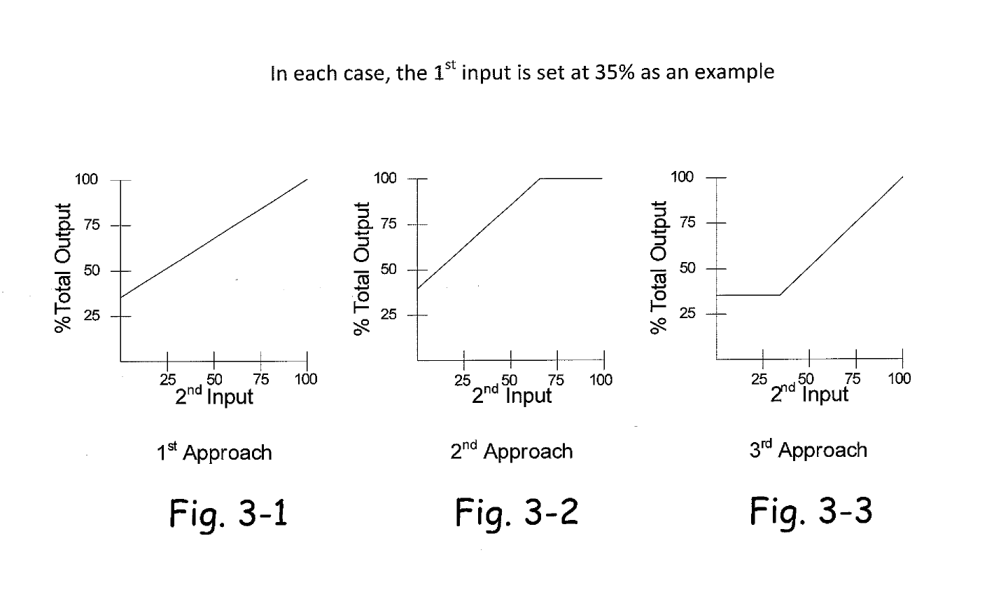

FIGS. 3-1 to 3-3 provide graphical illustrations of three different examples of how controller 220 can combine the first and second throttle input signals 206 and 211. In a first approach illustrated in the graph of FIG. 3-1, the second throttle input signal 211 is conditioned based in part on baseline throttle input established by the first throttle input signal 206. For example, assume that the first throttle input device 205 is positioned to establish a baseline throttle input of 35% of full throttle (i.e. 35% of the difference between a minimum sustainable engine speed to a maximum capable engine speed, the 35% being added to the minimum engine speed). In actuality, the baseline throttle level can be set to any percentage of the range of engine speed (or, in some embodiments, to any percentage with a range of the total engine speed) by adjusting by first throttle input device 205—35% is chosen merely as an illustrative example. The second throttle input signal 211 from second throttle input device 210 is then provided to a conditioning function and combined to the baseline input of 35% to create an output command input between 35% and 100% of full throttle. FIG. 3-1 illustrates an example of a linear conditioning function. In this example, the second throttle input signal 211 is scaled linearly so that over the range of motion of the second throttle input device 210, a signal between 0% and 65% of full throttle is added to the baseline input to create an output command signal 221. While the graph shown in FIG. 3-1 indicates a linear relationship between the position of the second throttle input device 210 and the second throttle input signal 211, any suitable relationship can be represented in the conditioning function.

In an alternative embodiment illustrated generally in FIG. 3-2, controller 220 is configured such that the conditioning of the second throttle input signal 211, results in an increasing output command signal 221 when the conditioned second throttle input signal 211 is combined with a baseline throttle over a first portion of travel of the second throttle input device 210 until the output command signal 221 reached 100% of the engine speed range. Additional travel of the second throttle input device to an end of travel results in no additional change to the output command signal 221—the output command signal remains at 100%. Thus, this portion of travel for the second throttle input device 210 is effectively a deadband.

In a third embodiment illustrated generally in FIG. 3-3, controller 220 is configured such that the second throttle input signal 211 is conditioned so that it is capable of providing a signal between 0% and 100% of the engine speed range. As with the embodiments described above with reference to FIGS. 3-1 and 3-2, the first throttle input signal 206 is established as a baseline throttle signal. If the second throttle input signal 211, once conditioned, is lower than the baseline throttle signal, the output command signal 221 is set to the baseline throttle signal. If the second throttle input signal 211, once conditioned, is a higher percentage than the baseline throttle signal, the output command signal 221 is set to the second throttle input signal 211. This effective creates a deadband at the beginning of travel for the second throttle input device 210.

In some embodiments, controller 220 is configured such that an operator of power machine 100 can select which of multiple engine speed control modes or methods to utilize in a particular operating situation or condition, or based solely on operator preference. For example, in these embodiments, the operator can chose which of the three operational modes illustrated in FIGS. 3-1 through 3-3, or other modes not specifically illustrated, is to be used to produce the output command signal 221 based on the outputs of the first and second throttle input devices 205 and 210. In these embodiments, an operator throttle mode selection input device 240 can optionally be provided in the operator compartment 142, or elsewhere on power machine 100. For example, the mode selection input device 240 can be a push button or other operator input device positioned on a joystick controller handle. The same joystick controller can also function as the first throttle input device 205 or the second throttle input device 210, but this need not be the case. Mode selection input device 240 can also be of a different type of operator input, such as a softkey input provided using a touch screen display, a toggle switch, etc. Using mode selection input device 240, a user causes a mode selection input signal 241 to be provided to controller 220. In response to the mode selection input signal 241, controller 220 processes the first throttle input signal 206 and the second throttle input signal 211 to generate output command signal 221 in accordance with the particular mode selected. Alternatively, the mode utilized by controller 220 can be reprogammably set using a service tool 250 that can be attached to the power machine for communication with onboard electronic modules and thereby with controller 220.

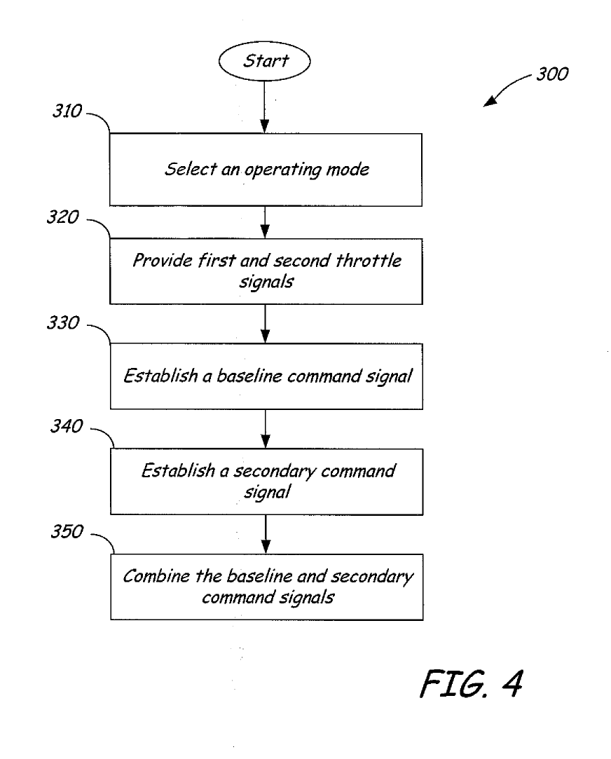

FIG. 4 illustrates a method 300 for controlling engine speed according to one illustrative embodiment. At block 310 of the method, an operating mode is selected for determining how the engine speed is controlled. The operating mode can be selected from any number of possible operating modes. For example, some embodiments may have only a single operating mode, so the step of selecting an operating mode includes selecting the same operating mode during every operation. In other embodiments, a plurality of operating modes are provided, as are shown in FIGS. 1-3. In such an embodiment, a controller of the type discussed above can choose from one of the plurality of modes. In most embodiments, this choice is made in response to an operator selection made by manipulating an operator input device.

At block 320 of the method, first and second throttle signals are provided. At block 330, a baseline command signal is established. The baseline command signal is illustratively a function of the first throttle signal. At block 340, a secondary command signal is established. The secondary command signal is a function of the second throttle signal. At block 350, the baseline and secondary command signals are combined to form a command signal for controlling the engine speed.

FIG. 4 is provided to illustrate basic concepts of method 300. It should be appreciated that in various embodiments, variations of this method can be employed. For example, in some embodiments, changing the operating mode, shown in block 310, can be performed at any time and repeatedly during a run cycle of the power machine. In other embodiments, the operating mode can be changed only at limited times, such as at the beginning of a run cycle of the power machine and alternatively, only when the engine is not actually running. Similarly, in some embodiments, the baseline command signal can be established whenever the first throttle signal changes (through manipulation of the first throttle input). Alternatively, the baseline command signal can be established only at limited times, such as when a run cycle of a machine begins only or, in some embodiments, when the power machine is not moving.

The embodiments above provide important advantages. By providing two different throttle devices, a baseline engine speed can be established at which the power machine can operate. By providing a second input device, an operator has a way to temporarily increase the engine speed while not altering the baseline engine speed so that when the operator desires to return to the baseline engine speed, the operator can do so by not manipulating the second throttle input device (for example, if the second throttle input device is biased toward an unactuated position, not manipulating the second throttle input device will allow it to return to an unactuated position) is or returning the second throttle input device to a particular position. By offering different operating modes in some embodiments, an operator can select an operation method of the second throttle device that is preferred either generally or for a particular application of the power machine, such as for use with a particular implement, in travel mode, or in a digging application, to name a few applications.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, in various embodiments, different types of power machines can include throttle engine speed control systems having one or more of the disclosed concepts. Further, other types or numbers of throttle input devices can be used, as can other selectable modes of operation for processing multiple throttle inputs to produce a combined ECU command signal. Other examples of modifications of the disclosed concepts are also possible, without departing from the scope of the disclosed concepts.

What is claimed is:

1. A power machine having a controllable power source that is configured to receive a command signal for controlling the power source, the power machine comprising:
a first throttle input device configured to provide a first throttle input signal indicative of actuation thereof;
a second throttle input device configured to provide a second throttle input signal indicative of actuation thereof;
a controller capable of receiving the first and second input signals and combine the first and second throttle input signals to generate the command signal.

2. The power machine of claim 1, wherein the power source includes a power source control unit in communication with the controller and configured to receive the command signal for controlling the power source.

3. The power machine of claim 1, wherein the power source is an engine and wherein the electronic control unit is configured to control engine speed based upon the command signal generated from the combined first and second throttle input signals.

4. The power machine of claim 3, wherein the controller is configured to calculate the command signal as a function of a baseline command signal, indicated by the first throttle input device and an offset signal, indicated by the second throttle input device, that is added to the baseline signal so that the command signal is between the baseline command signal a maximum command signal.

5. The power machine of claim 4, wherein the controller is configured to condition the second throttle input signal such that the offset signal is calculated over a full range of second throttle input device actuation.

6. The power machine of claim 4, wherein the second throttle input device is actuable from an unactuated position, through a first range of actuation, a second range of actuation, and to a fully actuated position and wherein the controller is configured to condition the second throttle input signal such that the offset signal is increased from over a first range of second throttle input device actuation, and such that additional actuation of the second throttle input device over a second range of second throttle input device actuation results in no additional change to the offset signal.

7. The power machine of claim 4, wherein the second throttle input device is actuable from an unactuated position and to a fully actuated position through a first range of actuation and a second range of actuation, and wherein the controller is configured to condition the second throttle input signal such that the offset signal remains unchanged over the first range of actuation, and such that the offset signal is increased over the second range of actuation.

8. The power machine of claim 4, wherein the controller is configured to condition the second throttle input signal based upon one of multiple throttle control modes, the power machine further comprising:
a throttle control mode selection input device operably coupled to the controller and configured to allow a user to select which of multiple throttle control modes is used to condition the second throttle input signal.

9. The power machine of claim 4, wherein the controller is configured to condition the second throttle input signal based upon a programmed throttle control mode which configures the controller, and wherein the controller is capable of reprogramming the throttle control modes in response to a reprogramming signal.

10. A throttle input control system for generating a command signal for controlling engine speed of a power machine, comprising:
a first throttle input device configured to provide a first throttle signal in response to actuation by an operator;
a second throttle input device configured to provide a second throttle signal in response to actuation by the operator; and
a controller operably coupled to the first and second throttle input devices to receive the first and second throttle signals and couplable to an electronic control unit that controls an engine for to providing the command signal to the electronic control unit, wherein the controller is configured to combine the first and second throttle input signals to generate the command signal.

11. The throttle input control system of claim 10, wherein the controller is configured to recognize the first throttle input device as a primary input and to use the first throttle input signal to set a baseline throttle signal used in generating the command signal, wherein the controller is further configured to recognize the second throttle input device as a secondary input and to condition the second throttle input signal for combining with the first throttle input signal to alter the command signal from between the baseline throttle signal and a maximum throttle signal based upon a position of the second throttle input device.

12. The throttle input control system of claim 11, wherein the controller is configured to condition the second throttle input signal such that the command signal is altered from the baseline throttle signal to the maximum throttle signal over a full range of second throttle input device positions.

13. The throttle input control system of claim 11, wherein the controller is configured to condition the second throttle input signal such that the command signal is increased from the baseline throttle signal to the maximum throttle signal over a first range of second throttle input device positions, and such that additional travel of the second throttle input device over a second range of second throttle input device positions results in no additional change to the output command signal.

14. The throttle input control system of claim 11, wherein the controller is configured to condition the second throttle input signal such that the command signal remains at the baseline throttle signal over a first range of second throttle input device positions, and such that the command signal is increased from the baseline throttle signal to the maximum throttle signal over a second range of second throttle input device positions.

15. The throttle input control system of claim 11, wherein the controller is configured to condition the second throttle input signal based upon one of a plurality of throttle control modes, further comprising a throttle control mode selection input device operably coupled to the controller and configured to allow a user to select which of multiple throttle control modes is used to condition the second throttle input signal.

16. A method of providing a command signal to control an engine speed on a power machine, comprising:
providing a first input signal indicative of actuation of a first throttle input device;
providing a second input signal indicative of actuation of a second throttle input device;
establishing a baseline command signal between a minimum engine speed signal and a maximum engine speed signal based on the first input signal;
establishing a secondary command signal based on the second input signal; and
combining the baseline command signal and the secondary command signal to form the command signal.

17. The method of claim 16, wherein establishing a secondary command signal includes scaling the secondary command signal to limit the secondary command signal to a difference between a maximum command signal and the baseline command signal.

18. The method of claim 17, and further comprising:
selecting a control mode from a plurality of control modes and wherein the secondary command signal is scaled according to the selected control mode.

19. The method of claim 17, wherein scaling the secondary command signal comprises:
establishing first and second ranges of actuation of the second throttle input device; and
wherein the secondary command signal is unchanged when the second throttle input device is in the first range of actuation and wherein the secondary command signal is scaled over the second range of actuation.
